(19) United States
(12) Patent Application Publication
(10) Pub. No.: US 2003/0219233 A1
(43) Pub. Date: Nov. 27, 2003

(54) DVD-video playback apparatus and subpicture stream playback control method

(76) Inventor: Masaru Kimura, Iwaki-city (JP)

Correspondence Address: BRINKS HOFER GILSON & LIONE, P.O. BOX 10395, CHICAGO, IL, 60611, US

(21) Appl. No.: 10/414,483

(22) Filed: Apr. 14, 2003

(30) Foreign Application Priority Data
Apr. 25, 2002 (JP) 2002-124805

(51) Int. Cl. H04N 5/781

(52) U.S. Cl. 386/95; 386/98; 386/125

(57) ABSTRACT

The responsiveness to a change of a subpicture stream is improved. Each stream processing section stores data of a corresponding subpicture stream. A selector connects the stream processing section corresponding to a subpicture stream to be played back to a subpicture drawing section. The subpicture drawing section obtains the data of the subpicture stream from the connected stream processing section and draws a subpicture image. Even if each stream processing section is not connected to the subpicture drawing section, the stream processing section operates on a variable for subpicture display control, which is operated on by a display control command contained in the data of the subpicture stream, so as to match the time specified by the data of the subpicture stream in accordance with the display command, and stores the variable. The subpicture drawing section draws the subpicture in accordance with the variable stored in the connected stream processing section.

### BACKGROUND OF THE INVENTION

1. Field of the Invention

The present invention relates to a technology for controlling the playback of subpicture streams in a DVD-video playback apparatus for playing back a presentation recorded on a DVD-video disk.

2. Description of the Related Art

In DVD-video disks defined by the DVD-video standard, it is possible for a provider of content to insert, in the content, subpictures which are displayed in such a manner as to be combined with the main video. Furthermore, a stream of a plurality of subpictures can be defined in the content, a stream of subpictures can be selected according to the mode of the DVD-video playback apparatus and user specification, and the subpictures belonging to the selected stream can be displayed in such a manner as to be combined with the main video.

Here, the subpictures are recorded on or read from a DVD-video disk in an interleaved form together with video and audio data, etc., in units called “SPUs” (subpicture units), as shown in, for example, part (a) of FIG. 8. The example shown in the figure shows a situation in which an SPU of subpicture stream number 1 (SPU_ST1), an SPU of subpicture stream number 2 (SPU_ST2), and an SPU of subpicture stream number 3 (SPU_ST3) are read in the order in which they are recorded on the DVD-video disk.

One SPU allows the display contents of subpictures of a subpicture stream to which that SPU belongs to be defined in a period, at most, from the completion of reading of SPU from the DVD-video disk until the next SPU of the subpicture stream to which the SPU belongs is read. For example, as in the example shown in part (b) of FIG. 8, when the subpicture stream of the subpicture stream number 1 has been selected (SEL ST1), with respect to the reading of each SPU shown in part (a) of FIG. 8, the subpicture defined by each read SPU_ST1 can be displayed until the reading of the next SPU_ST1 is completed.

Here, in the DVD-video playback apparatus, at each point in time, only the SPU of the subpicture stream of the selected subpicture stream number is selectively stored, processing in accordance with the contents of the stored SPU is performed, and the SPUs of the other subpicture streams are discarded, thereby performing the display of the subpicture of the selected subpicture stream such as that described above.

Therefore, for example, as shown in part (a) of FIG. 8, in a case where SPUs of individual subpicture streams are present, when, as shown in part (c) of FIG. 8, the subpicture stream of the subpicture stream number 1 is selected (SEL ST1), if the subpicture stream is changed to the subpicture stream of the subpicture stream number 2 in accordance with an instruction OP(ST2) from the user for changing the subpicture stream, the subpictures of the selected subpicture stream of the subpicture stream number 2 cannot be displayed during a time t from the point when the subpicture stream of the subpicture stream number 2 has been selected (SEL ST2) until the point when reading of the next SPU_ST2 is completed.

For this reason, when the time interval for reading the SPU of a certain subpicture stream is large, it takes a long time from the point when the user gives an instruction to change the subpicture stream until the subpictures of that subpicture stream are actually displayed. Thus, such a conventional subpicture stream changing technique has a problem in that it is not highly responsive to user operations.

### SUMMARY OF THE INVENTION

Accordingly, an object of the present invention is to improve the responsiveness to an instruction for changing a subpicture stream in a DVD-video playback apparatus.

To achieve the above-mentioned object, in one aspect, the present invention provides a DVD-video playback apparatus for playing back a presentation containing a plurality of subpicture streams recorded on a DVD-video disk, the DVD-video playback apparatus comprising: a data reading section for reading data of the presentation from the DVD-video disk; a subpicture stream data storage section for storing, for each subpicture stream, the data of each subpicture stream which is contained in the data of the presentation read by the data reading section; a subpicture playback section for playing back a subpicture stream from the data of the subpicture streams; and a subpicture stream data selection section for selecting the data of a subpicture stream to be played back by the subpicture playback section, from among the data of each subpicture stream stored by the subpicture stream data storage section, in accordance with a change of the subpicture stream to be played back.

According to such a DVD-video playback apparatus, with regard to not only the subpicture stream being played back, but also the subpicture stream which is not being played back, the data read from the DVD-video disk is stored, and when an instruction for changing the subpicture stream to the subpicture stream having data stored therein is given, the subpicture stream is played back from the stored data of the subpicture stream. Therefore, the playback of the changed subpicture stream can be started immediately without waiting for the data of the changed subpicture stream to be read from the DVD-video disk after the subpicture stream change has been instructed, and thus the responsiveness to the instruction for changing a subpicture stream can be improved.

The configuration of such a DVD-video playback apparatus can be applied to any playback apparatus for selecting a stream from among a plurality of streams and playing back the stream by replacing the subpicture stream with the stream handled by the playback apparatus.

More specifically, in another aspect, the present invention provides a DVD-video playback apparatus for playing back a presentation containing a plurality of subpicture streams recorded on a DVD-video disk, the DVD-video playback apparatus comprising: a data reading section for reading data of the presentation from the DVD-video disk; a plurality of stream processing sections provided in such a manner as to correspond to the plurality of subpicture streams; a selection section for selecting one stream processing section from among the plurality of stream processing sections; and a subpicture playback section for playing back a subpicture stream. Each of the stream processing sections stores data of the most recent subpicture unit (SPU) of the subpicture stream corresponding to the stream processing section itself, which is contained in the data of the presentation read by the data reading section; the selection section changes the stream processing section to be selected to the stream processing section corresponding to the subpicture stream after being changed in accordance with a change of the subpicture stream to be played back; and the subpicture playback section plays back a subpicture in accordance with the data of the subpicture unit stored by the stream processing section selected by the selection section.

In such a DVD-video playback apparatus, when the stream processing section selected by the selection section is changed, the subpicture playback section computes the value of a variable for subpicture display control at the current time, which is specified by a subpicture display control sequence table (SP_DCSQT) contained in the data of the subpicture unit stored by the selected stream processing section, and controls the display of pixel data (PXD) contained in the data of that subpicture unit in accordance with the computed value of the variable, thereby performing a first playback of the subpicture indicated by the data of that subpicture unit.

As a result of the above, even when the subpicture stream is changed in the middle of the effective period of the subpicture unit, the display of the subpicture can be made at each point in time to be a display intended by the provider of the presentation.

In another aspect, the present invention provides a DVD-video playback apparatus for playing back a presentation containing a plurality of subpicture streams recorded on a DVD-video disk, the DVD-video playback apparatus comprising: a data reading section for reading data of the presentation from the DVD-video disk; a plurality of stream processing sections provided in such a manner as to correspond to the plurality of subpicture streams; a selection section for selecting one stream processing section from among the plurality of stream processing sections; and a subpicture playback section for playing back a subpicture stream, wherein each of the stream processing sections stores the pixel data (PXD) contained in the most recent subpicture unit (SPU) of the subpicture stream corresponding to the stream processing section itself, which is contained in the data of the presentation read by the data reading section, computes the value of a variable for subpicture display control at the current time, which is specified by the subpicture display control sequence table (SP_DCSQT) contained in the data of that subpicture unit, and stores the value, the selection section changes the stream processing section to be selected to the stream processing section corresponding to the subpicture stream after being changed in accordance with a change of the subpicture stream to be played back, and the subpicture playback section plays back a subpicture by controlling the display of pixel data stored by that stream processing section in accordance with the value of the variable stored by the stream processing section selected by the selection section.

In such a DVD-video playback apparatus, even when the subpicture stream is changed in the middle of the effective period of the subpicture unit, the display of the subpicture can be made at each point in time to be a display intended by the provider of the presentation. Also, since the computation of the value at the current time of the variable for display control of the subpicture stream after being changed, which is required for the above display, can be prevented from occurring as an overhead after the subpicture stream is changed, it is possible to quickly display the subpicture of the subpicture stream after being changed.

In the above-described DVD-video playback apparatus comprising the stream processing section, the stream processing section may decode and store pixel data (PXD) contained in the most recent subpicture unit (SPU) of the subpicture stream corresponding to the stream processing section itself.

As a result of the above, after the subpicture stream is changed, an overhead due to the decoding of the pixel data of the changed subpicture stream can be prevented from occurring, and the display of the subpicture of the changed subpicture stream can be performed quickly.

Furthermore, in the above-described DVD-video playback apparatus, the stream processing section may store the data of only the subpicture stream corresponding to the current display aspect ratio and/or the current display mode, which are determined by referring to a program chain subpicture stream control table (PGC_SPST_CTLT) of program chain information (PGCI) of the program chain (PGC) currently being played back, and the stream processing section may store the data of only the subpicture stream corresponding to a predetermined language code and/or a predetermined language code extension, which are determined by referring to a subpicture stream attribute table (SPST_ATRT) of the presentation currently being played back.

As a result of the above, processing may be performed on only the subpicture stream which is considered to be necessary, and the number of processes of the DVD-video playback apparatus can be reduced. Furthermore, for example, when a plurality of stream processing sections are provided in the manner described above, it suffices to provide a stream processing section with regard to only the subpicture stream which is considered to be necessary. For example, when the DVD-video playback apparatus is operated by software, and the stream processing section is dynamically generated as a process, the process of the stream processing section may be generated for only the necessary subpicture stream.

### BRIEF DESCRIPTION OF THE DRAWINGS

FIG. 1 is a block diagram showing the configuration of a DVD-video playback apparatus according to an embodiment of the present invention;

FIG. 2 shows a playback structure in the DVD-video standard;

FIG. 3 shows a data structure in the DVD-video standard;

FIG. 4 shows a data structure in the DVD-video standard;

FIG. 5 is a block diagram showing the configuration of a subpicture processing section according to the embodiment of the present invention;

FIG. 6 shows a subpicture stream changing operation by the DVD-video playback apparatus according to the embodiment of the present invention;

FIG. 7 is a block diagram showing another example of the configuration of a subpicture processing section according to the embodiment of the present invention; and

FIG. 8 shows a subpicture stream changing operation by a conventional DVD-video playback apparatus.

### DETAILED DESCRIPTION OF THE INVENTION

The preferred embodiment of the present invention will now be described below.

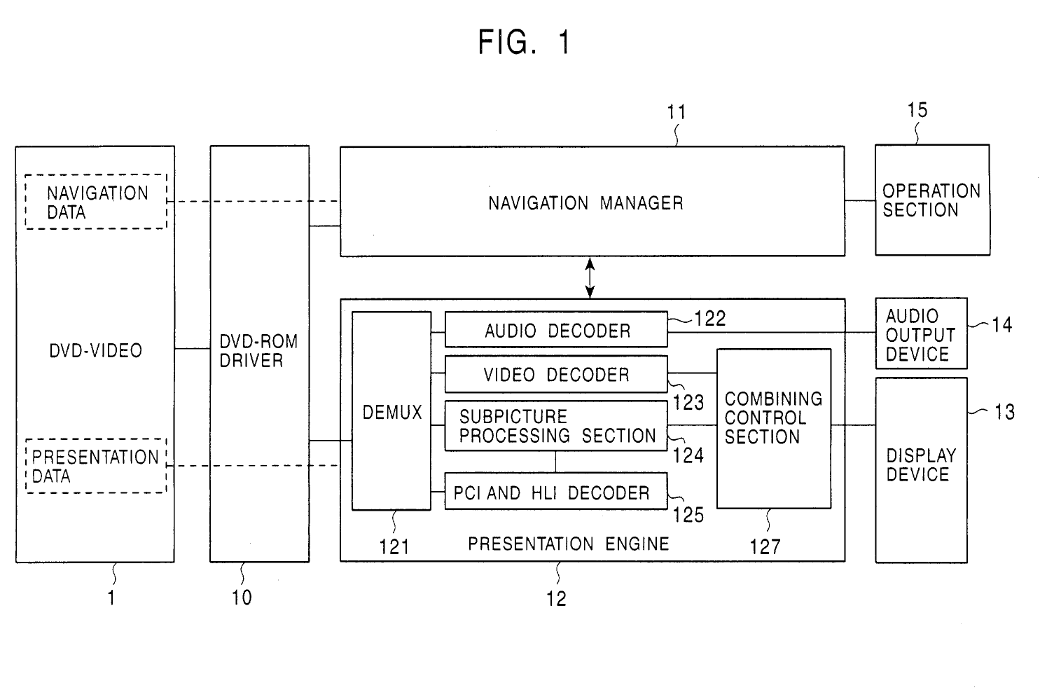

FIG. 1 shows the configuration of a DVD-video playback apparatus according to this embodiment. As shown in FIG. 1, the DVD-video playback apparatus comprises a DVD-ROM driver 10 for making read-access to a DVD-video disk 1, a navigation manager 11, a presentation engine 12 for playing back video, a display device 13 for producing a moving image, an audio output device 14, such as a speaker for outputting audio, and an operation section 15, such as a remote controller.

The DVD-video disk 1 has a lead-in area and a lead-out area in conformance with the DVD-ROM standard (physical standard), and a data area provided between those areas. In the data area, a volume structure area in which the volume structure is described in accordance with the UDF (Universal Disk Format)-Bridge standard (file standard), and a data structure area in which the data structure is described in accordance with the UDF-Bridge standard (file standard) are provided. Furthermore, in the data area, a file group composed of a plurality of files is stored, and the data in the group of these files is application data in conformance with the DVD-video standard. This application data is broadly formed of presentation data having stored therein presentation entities such as audio data, moving-image data, subpicture data, highlight information, etc., and navigation data for controlling the playback of the presentation.

In the presentation engine 12, a demultiplexer 121 reads presentation data from the DVD-video disk 1 and extracts audio data, moving-image data, subpicture data, highlight information, etc., from the presentation data. An audio decoder 122 decodes the extracted audio data, and provides the data to the audio output device 14. A video decoder 123 decodes the extracted moving-image data. A subpicture processing section 124 decodes subpictures while using highlight information decoded by a PCI (program control information) and HLI (highlight information) decoder 125. Thus, a subpicture image is generated. A combining control section 127 combines the decoded moving images and the subpicture image, and supplies them to the display device 13.

The navigation manager 11 determines the playback sequence of the presentation in accordance with the navigation data which is read using the DVD-ROM driver 10 and user operations received from the operation section 15, and controls the playback/output operation of the presentation engine 12 in the determined playback sequence.

In the DVD-video standard, an example of the structure defined for the playback of the presentation data will now be briefly described.

The playback sequence of each presentation is specified by one or more program chains PGC, and program chain information PGCI defines the structure of a PGC.

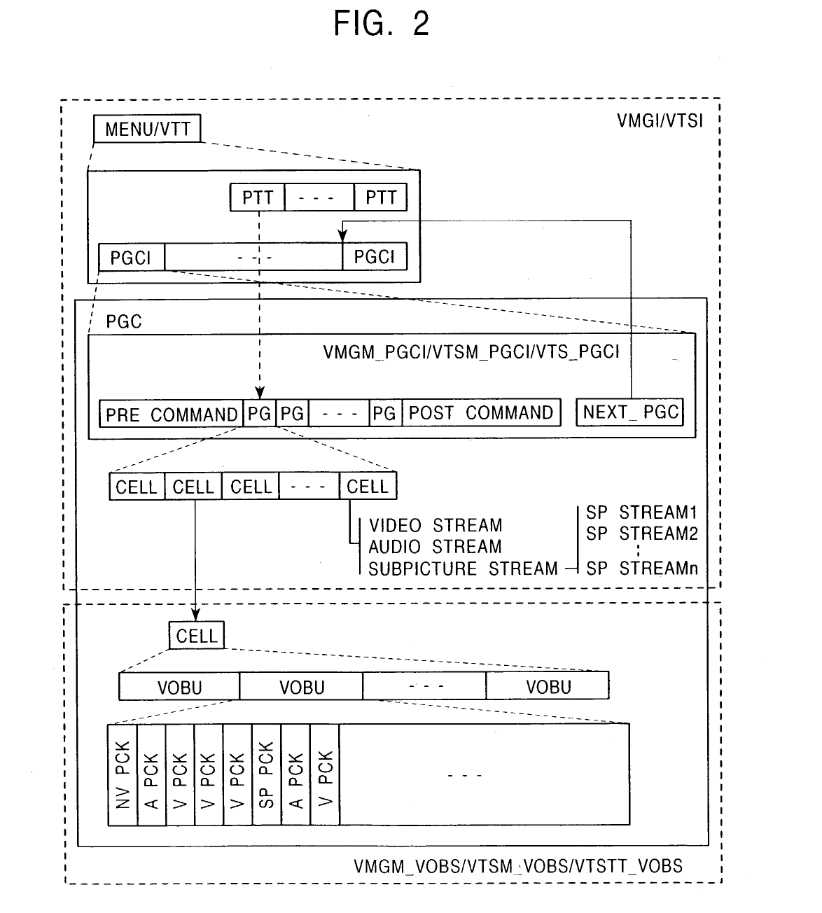

FIG. 2 shows the playback structure of a PGC, and a program PG contained in the PGC and a playback sequence of PGs are defined by the PGCI. Furthermore, the PGCI can contain the commands PRE_COMMAND and POST_COMMAND to be executed at the PGC playback start time and the termination time, and a description NEXT_PGC of the PGCI to be executed next.

Each PG is made up of one or more cells CELL. Each cell CELL contains a video stream, an audio stream, and a subpicture stream; a plurality of subpicture streams (SP STREAM1 to SP STREAMn) can be contained as the subpicture stream.

Each cell of the data structure is made up of a plurality of video object units VOBU, and each VOBU can have one navigation pack NV_PCK, as well as a plurality of video packs V_PCKs, a plurality of audio packs A_PCKs, and a plurality of subpicture packs SP_PCKs. In the video packs V_PCK, data of a video stream is stored; in the audio packs A_PCKs, data of an audio stream is stored; and in the subpicture packs SP_PCKs, data of a subpicture stream is stored.

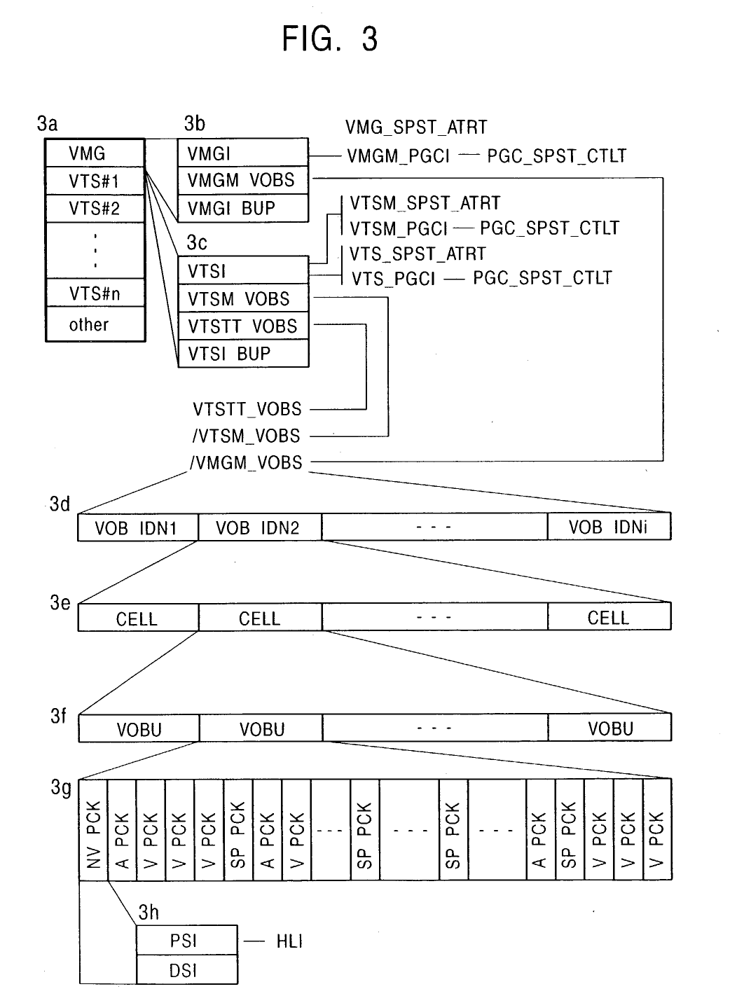

For a presentation whose playback is controlled by the PGCI in the above-described manner, there are three types: presentation of a menu for the entire title, presentation of a menu which is commonly used with respect to a plurality of titles, and presentation of individual titles. For each of them, a playback structure such as that described above is defined by the data structure shown in FIG. 3 in the presentation data in conformance with the DVD-video standard.

As shown in FIG. 3, application data in conformance with the DVD-video standard contains a video manager VMG, which is menu data for the entire title, and a video title set VTS, which is data for a plurality of titles (part (a) of FIG. 3).

The VMG contains video manager information VMGI and a video object set VMGM_VOBS for the video manager menu. The VMGI contains VMGM_PGCI, which is PGCI for controlling the playback of the presentation of the menu for the entire title, and a subpicture stream attribute table VMG_SPST_ATRT for specifying the attributes of each subpicture stream contained in the presentation of the menu for the entire title. The VMGM_PGCI contains a PGC subpicture stream control table PGC_SPST_CTLT (part (b) of FIG. 3). The subpicture stream attribute table VMG_SPST_ATRT specifies, for each subpicture stream, a language code indicating the language of subtitles when each subpicture stream used in the VMG indicates subtitles, and a language code extension indicating whether, when each subpicture stream used in the VMG indicates subtitles, the contents thereof are intended for children, and indicating whether the size of the characters is large or normal.

On the other hand, in the PGC subpicture stream control table PGC_SPST_CTLT, the correspondence between the subpicture stream numbers and the decoding subpicture stream numbers is specified. The decoding subpicture stream number is a number used to specify the data of each subpicture stream formed by the above-described SP_PCK, and the subpicture stream number is a number used to specify a subpicture stream by a user or the navigation manager 11. For one subpicture stream number of the video stream, a display aspect ratio, such as 4:3 or 16:9, and a decoding subpicture stream number for each video stream display mode, such as wide, letter box, and pan-and-scan, can be assigned. Therefore, the subpicture stream numbers and the decoding subpicture stream numbers need not necessarily have a one-to-one correspondence.

On the other hand, the VTS contains video title set information VTSI, a video object set VTSM_VOBS for a video title set menu, and a video object set VTSTT_VOBS for a video title set title. The VTSI contains VTSM_PGCI, which is PGCI for controlling the playback of the presentation of a menu, which is commonly used for the titles within the VTS by using the VTSM_VOBS, and the subpicture stream attribute table VTSM_SPST_ATRT which specifies the attributes of each subpicture stream contained in the presentation of a menu, which is commonly used for the titles within the VTS. Furthermore, the VTSI contains VTS_PGCI, which is PGCI for controlling the playback of the presentation of individual titles by using VTSTT_VOBS, and a subpicture stream attribute table VTS_SPST_ATRT for specifying the attributes of each subpicture stream contained in the presentation of individual titles (part (c) of FIG. 3). The VTSM_PGCI and the VTS_PGCI contain the above-described PGC subpicture stream control table PGC_SPST_CTLT. Furthermore, the VTSM_SPST_ATRT and the VTS_SPST_ATRT contain the same contents as those of the above-described VMG_SPST_ATRT.

Each VOBS of VMGM_VOBS, VTSM_VOBS, and VTSTT_VOBS has one or more video objects VOBs (part (d) of FIG. 3), and each VOB has one or more CELLS (part (e) of FIG. 3). As described above, each CELL has one or more VOBUs (part (f) of FIG. 3). Each VOBU can have one NV_PCK, as well as a plurality of V_PCKs, a plurality of A_PCKs, and a plurality of SP_PCKs (part (g) of FIG. 3). Furthermore, the NV_PCK has playback control information PCI and data search information DSI (part (h) of FIG. 3). The playback control information PCI contains highlight information HLI for defining a button area on a subpicture image and controlling the display color of the button.

The above PCI, DSI, VMGI, and VTSI roughly correspond to the above-described navigation data, and the portions excluding the NV_PCK of the VOBU roughly correspond to the above-described presentation data. The blocks shown in broken lines in FIG. 2 show the correspondence between the playback structure of the presentation and the PGCI and VOBS in the above data structure.

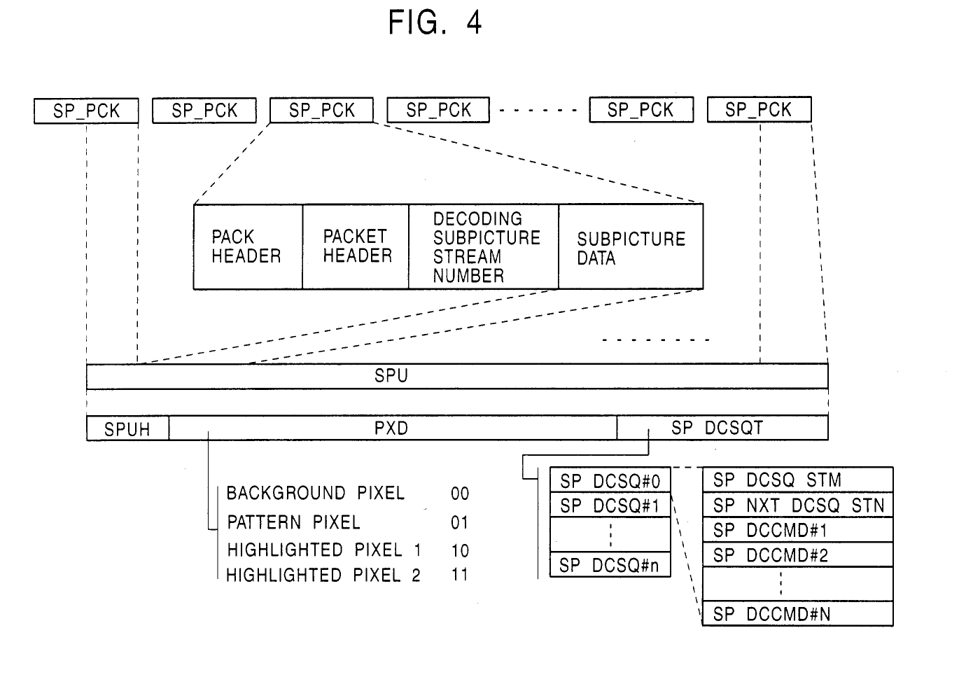

Next, as shown in FIG. 4, the SP_PCK is formed of a pack header, a packet header, a decoding subpicture stream number, subpicture data, etc., and the subpicture data of a plurality of SP_PCKs having the same decoding subpicture stream number forms one subpicture unit SPU of that decoding subpicture stream number. The subpicture unit SPU is formed of a subpicture unit header SPUH, pixel data PXD, and a subpicture display control sequence table SP_DCSQT. The pixel data PXD comprises data of pixels of a compressed and coded subpicture image. The subpicture image is an image whose pixel value (pixel depth) is two bits, and each pixel is one of a background pixel, a pattern pixel, a highlighted pixel 1, and a highlighted pixel 2 according to the pixel value thereof.

The subpicture display control sequence table SP_DCSQT has one or more display control sequences SP_DCSQ#, and in each display control sequence SP_DCSQ#, an execution start time SP_DCSQ_STM of a display control sequence, and a starting address SP_NXT_DCSQ_SA of the next display control sequences SP_DCSQ#, and one or more display control commands SP_DCCMD are stored. When the execution start time SP_DCSQ_STM of the display control sequence is reached, the display control command SP_DCCM of each display control sequence SP_DCSQ# is executed in sequence in the described order.

The display control commands SP_DCCMD include FSTA_DSP for setting a timing at which the display of a subpicture is started regardless of the setting of the presence or absence of the display of a subpicture by a user; STA_DSP for setting a timing at which the display of a subpicture is started; STP_DSP for setting a timing at which the display of a subpicture is stopped; SET_COLOR for setting the color of a background pixel, a pattern pixel, a highlighted pixel 1, and a highlighted pixel 2; SET_CONTR for setting the mixture ratio when the background pixel, the pattern pixel, the highlighted pixel 1, and the highlighted pixel 2 are combined with video in the combining control section 126; SET_DAREA for setting the display area on the display screen of the subpicture; SET_DSPXA for setting the starting address of pixel data to be displayed as a subpicture on the display area; CHG_COLCON for setting pixel control data PXCD for specifying the change position of the pixel data and the change contents of the colors and the contrast of the background pixel, the pattern pixel, the highlighted pixel 1, and the highlighted pixel 2; and CMD_END for terminating the display control sequence. Here, variables operated on by each of the above display control commands SP_DCCMD are the forced display start time FSTA, the display start time STA, the display stop time STP, the color COLOR, the contrast CONTR, the display area DAREA, the display starting address DSPXA, and the pixel control data PXCD. The display of the subpicture generated from the pixel data is controlled in accordance with these variables.

A description will now be given below of the operation of displaying a subpicture stream in such a DVD-video playback apparatus.

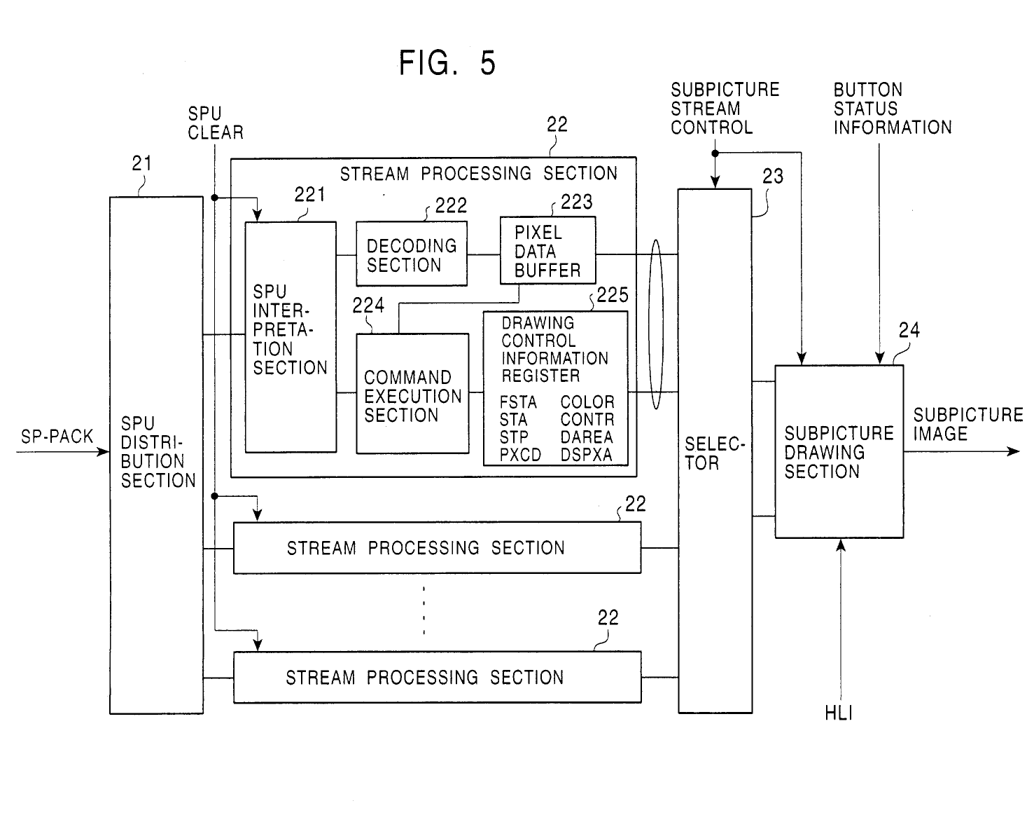

FIG. 5 shows the configuration of the subpicture processing section 124 shown in FIG. 1.

As shown in FIG. 5, the subpicture processing section 124 comprises an SPU distribution section 21, a plurality of stream processing sections 22, a selector 23, and a subpicture drawing section 24. Each stream processing section 22 is provided in such a manner as to correspond to one decoding subpicture stream, and comprises an SPU interpretation section 221, a decoding section 222, a pixel data buffer 223, a command execution section 224, and a drawing control information register 225. The drawing control information register 225 stores the forced display start time FSTA, the display start time STA, the display stop time STP, the color COLOR, the contrast CONTR, the display area DAREA, the display starting address DSPXA, and the pixel control data PXCD, which are the variables operated on by the above-described display control commands SP_DCCMD.

The maximum number of decoding subpicture streams is 32, and the maximum number of stream processing sections 22 is 32.

The operation of such a subpicture processing section 124 will now be described below.

In FIG. 1, a demultiplexer 121 demultiplexes SP_PCKs within the data read from the DVD-video disk 1 by the DVD-ROM driver 10, and supplies them to the subpicture processing section 124. In the subpicture processing section 124, the SPU distribution section 21 receiving the SP_PCKs determines the decoding subpicture stream to which each SP_PCK belongs on the basis of the decoding subpicture stream number of the SP_PCK, and supplies each SP_PCK to the stream processing section 22 corresponding to the decoding subpicture stream to which that SP_PCK belongs.

In each stream processing section 22, the SPU interpretation section 221 reconstructs the SPU from the received SP_PCKs. Furthermore, if a new SPU input is detected, the SPU interpretation section 221 clears the contents of a pixel data buffer 223 and a drawing control information register 225, sends the pixel data PXD to the decoding section 222, and sends the subpicture display control sequence table SP_DCSQT to the command execution section 224.

The decoding section 222 decodes the received pixel data PXD and stores it in the pixel data buffer 223. On the other hand, with regard to each display control sequence SP_DCSQ# in the received subpicture display control sequence table SP_DCSQT, when the execution start time SP_DCSQ_STM of the display control sequence of the display control sequence SP_DCSQ matches the current time, the command execution section 224 executes each display control command SP_DCCMD of the display control sequence SP_DCSQ in the described order, and updates the variable in the drawing control information register 225.

Furthermore, when the STP_DSP, which is a display control command SP_DCCMD, is to be executed, the command execution section 224 performs a process of clearing the contents of the pixel data buffer 223 and the drawing control information register 225. Furthermore, when the SPU interpretation section 221 is instructed to perform SPU clear from the navigation manager 11, the SPU interpretation section 221 performs a process of clearing the contents of the pixel data buffer 223 and the drawing control information register 225. The instruction for SPU clear from the navigation manager 11 is issued when the playback of the cell CELL is terminated.

Next, the selector 23 connects, to the subpicture drawing section 24, the pixel data buffer 223 and the drawing control information register 225 of the stream processing section 22 corresponding to the decoding subpicture stream number specified by the subpicture stream control information received from the navigation manager 11. When, for example, the navigation manager 11 is instructed from the user through the operation section 15 that the subpicture stream of a particular subpicture stream number is to be displayed or when it is determined by a predetermined subpicture stream selection algorithm that a particular subpicture stream should be displayed, the navigation manager 11 determines the decoding subpicture stream number corresponding to the subpicture stream number to be displayed, and the decoding subpicture stream number corresponding to the current display aspect ratio and/or the current display mode by referring to the PGC_SPST_CTLT of the PGCI of the PGC currently being played back, and specifies the determined decoding subpicture stream number by the subpicture stream control information.

The subpicture drawing section 24 reads the drawing control information register 225 of the stream processing section 22, which is connected by the selector 23, and determines whether or not the current time is within a period during which a subpicture should be displayed on the basis of the FSTA, STA, and STP of the drawing control information register 225 and the specification of subpicture display on/off, which is specified by the subpicture stream control information received from the navigation manager 11. In a case where the display “on” is specified from the navigation manager 11, when the current time is between the STA and STP, it is determined that the current time is within a period during which a subpicture should be displayed. In a case where the display “off” is specified from the navigation manager 11, the FSTA of the drawing control information register 225 has been set, and when the current time is between the FSTA and the STP, it is determined that the current time is within a period during which a subpicture should be displayed.

Then, if the current time is within a period during which a subpicture should be displayed, by using the COLOR, CONTR, DAREA, DSPXA, and PXCD of the connected drawing control information register 225, the highlight information HLI from the PCI and HLI decoder 125, and the button status information indicating the button selected/determined status received from the navigation manager 11, the pixel data stored in the connected pixel data buffer 223 is drawn to generate a subpicture image, and this image is supplied to the combining control section 126.

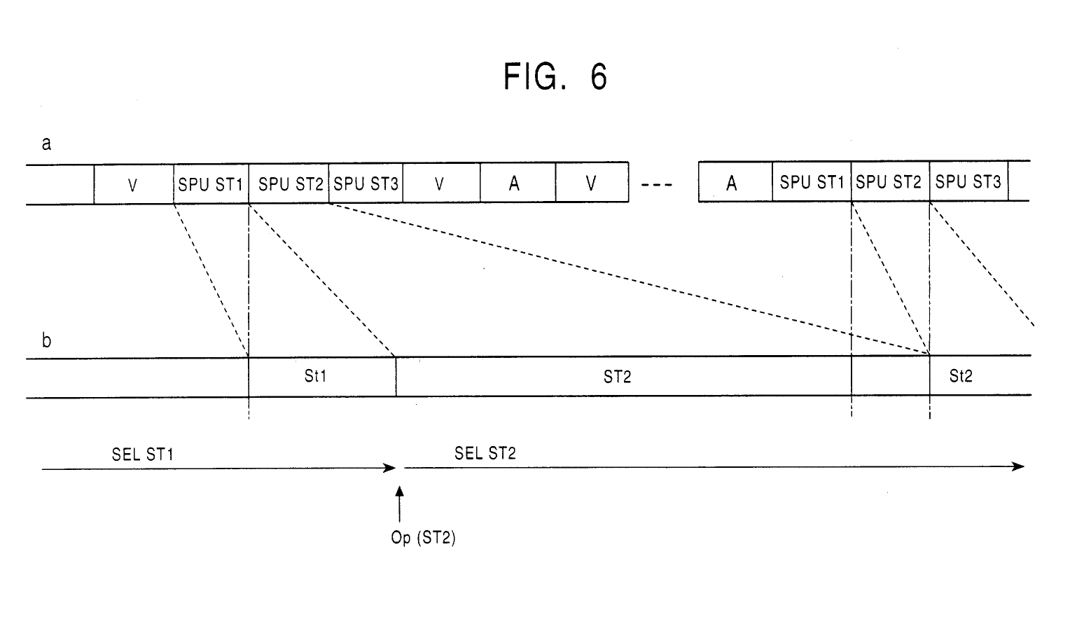

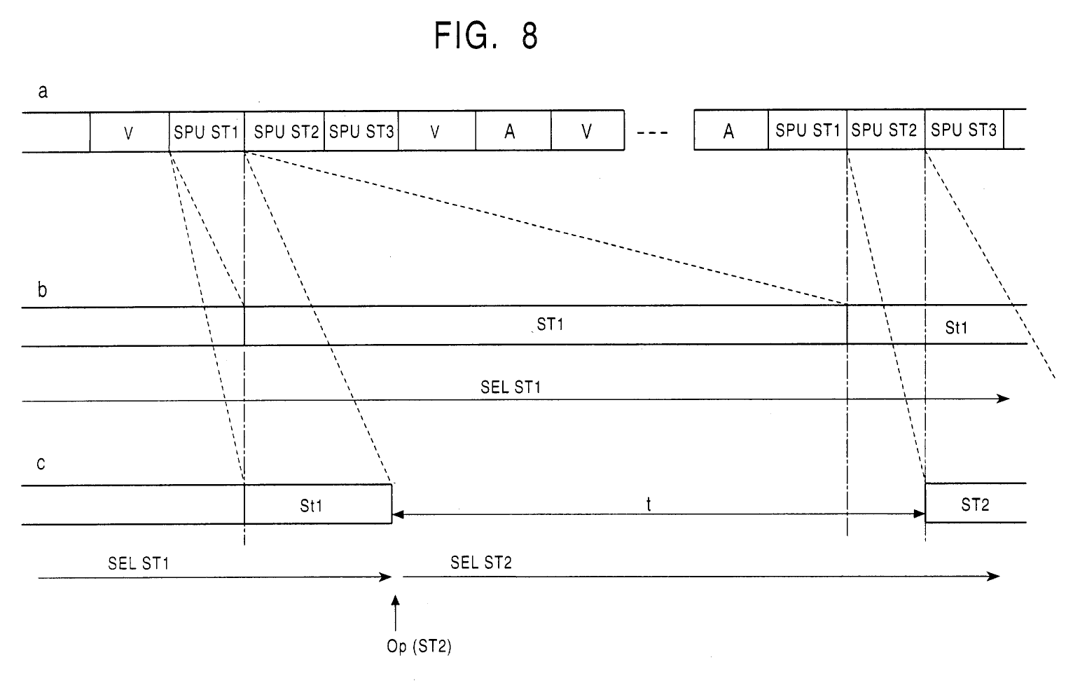

The above-described command execution section 224 operates so that, in a state in which, for example, as shown in part (a) of FIG. 6, when the SPU of each subpicture stream is located, for example, as shown in part (b) of FIG. 6, and the subpicture stream of the subpicture stream number 1 has been selected (SEL ST1), when an instruction OP(ST2) for changing the subpicture stream to the subpicture stream of the subpicture stream number 2 is entered by the user, SPU_ST2 of the decoding subpicture stream number corresponding to the subpicture stream number 2 which is read before being input is stored by the stream processing section 22 corresponding to the decoding subpicture stream number, and the variable for drawing the subpicture image, of the drawing control register matches the current time. Therefore, by only changing the stream processing section 22 connected to the subpicture drawing section 24 to the above stream processing section 22, the subpicture of the selected subpicture stream of the subpicture stream number 2 can be displayed immediately after the subpicture stream of the subpicture stream number 2 is selected (SEL ST2) in response to the change instruction OP(ST2). That is, when compared with the conventional subpicture stream change technique shown in part (c) of FIG. 8, higher responsiveness to user operations is made possible.

Furthermore, for example, when forwarding of a playback operation is performed, if the time at which the forwarding is terminated is within the effective period of the SPU which was read before the forwarding was started, the display of the subpicture image can be performed immediately after the forwarding is terminated.

In the foregoing, an embodiment of the present invention has been described.

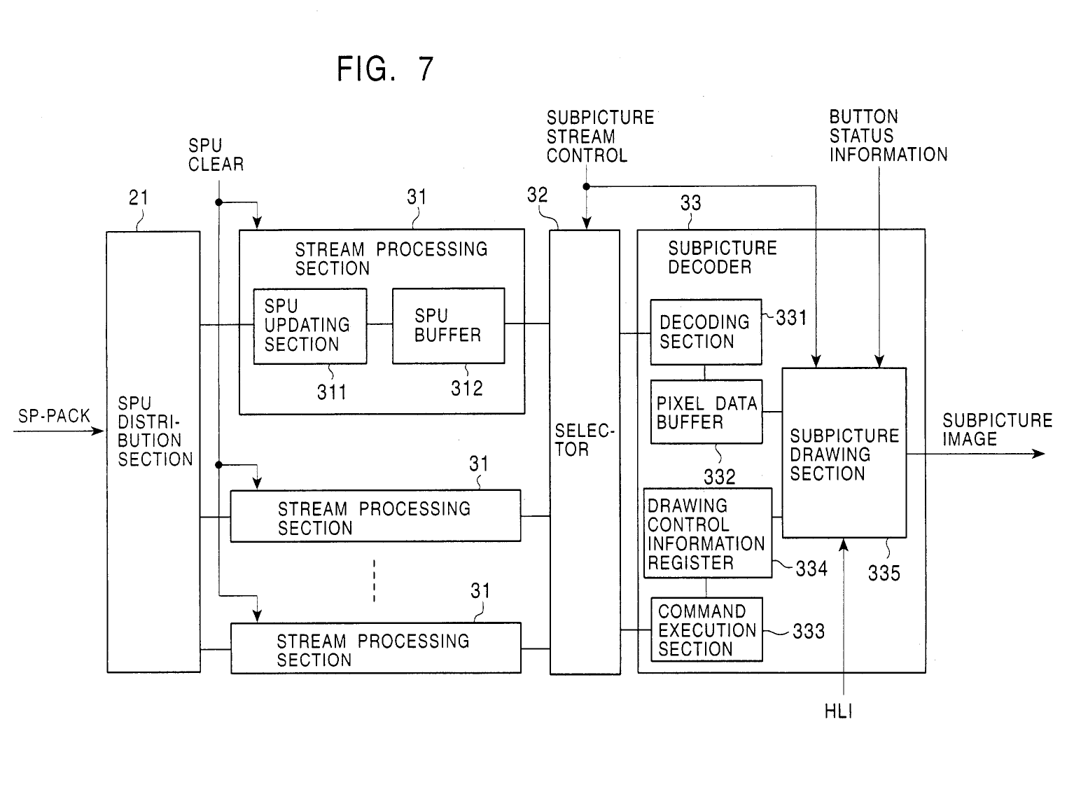

Alternatively, the above-described subpicture processing section 124 can be configured as shown, for example, in FIG. 7.

The command execution section 224 shown in FIG. 7 comprises an SPU distribution section 21, a plurality of stream processing sections 31, a selector 32, and a subpicture decoder 33. Each stream processing section 31 is provided so as to correspond to one decoding subpicture stream, and comprises an SPU interpretation section 311, and an SPU buffer 312. Then, the subpicture decoder 33 comprises a decoding section 331, a pixel data buffer 332, a command execution section 333, a drawing control information register 334, and a subpicture drawing section 335.

The SPU distribution section 21 determines the decoding subpicture stream to which each SP_PCK belongs on the basis of the decoding subpicture stream number of the SP_PCK received from the demultiplexer 121, and supplies each SP_PCK to the stream processing section 31 corresponding to the decoding subpicture stream to which that SP_PCK belongs. In each stream processing section 31, the SPU interpretation section 311 reconstructs the SPU from the received SP_PCK, and stores it in the SPU buffer 312. At this time, the old SPU stored in the SPU buffer 312 is deleted. Furthermore, when the SPU interpretation section 311 is instructed to perform SPU clear from the navigation manager 11, the SPU interpretation section 311 performs a process for clearing the contents of the SPU buffer 312.

Next, the selector 32 connects, to the subpicture decoder 33, the SPU buffer 312 of the stream processing section 31 corresponding to the decoding subpicture stream number specified by the subpicture stream control information from the navigation manager 11.

When the connected SPU buffer 312 is changed, the decoding section 331 of the subpicture decoder 33 decodes the extracted pixel data PXD from the SPU stored in the connected SPU buffer 312, and stores the data in the pixel data buffer 332. On the other hand, when the connected SPU buffer 312 is changed, the command execution section 333 performs, in the described order, all of the display control commands SP_DCCMD of the display control sequence SP_DCSQ, in which the execution start time SP_DCSQ_STM of the display control sequence is past the current time, from among the display control sequences SP_DCSQ# in the subpicture display control sequence table SP_DCSQT from the SPU stored in the connected SPU buffer 312, updates each variable in the drawing control information register 334, and instructs the subpicture drawing section 335 to start the drawing process. Thereafter, the command execution section 333 executes each display control command SP_DCCMD of the display control sequence SP_DCSQ, in which the execution start time SP_DCSQ_STM of the display control sequence matches the current time, in the described order, and updates each variable in the drawing control information register 334.

Alternatively, instead of executing all the display control commands SP_DCCMD of the display control sequence SP_DCSQ in which the execution start time SP_DCSQ_STM of the display control sequence is past the current time in the described order, the command execution section 333 may perform processing so that only the oldest display control command SP_DCCMD is executed, from the current time toward the past, for the same kind of display control commands SP_DCCMD of the display control sequence SP_DCSQ in which the execution start time SP_DCSQ_STM of the display control sequence is past the current time (while processing the display control command SP_DCCMD in an order reverse to the description of the display control sequence SP_DCSQ, the display control sequence SP_DCSQ is processed in an order reverse to the description of the subpicture display control sequence table SP_DCSQT). Even with this process, each variable in the drawing control information register 334 can be matched with the current time.

When the command execution section 333 executes the STP_DSP, which is a display control command SP_DCCMD, the command execution section 333 performs a process of clearing the contents of the pixel data buffer 332, the drawing control information register 334, and the connected SPU buffer 312.

When the connected SPU buffer 312 is changed, the subpicture drawing section 335 stops the output of the subpicture image to the combining control section 126. Thereafter, when the starting of the drawing process is instructed from the command execution section 333, the subpicture drawing section 335 determines whether or not the current time is within a period during which a subpicture should be displayed on the basis of the FSTA, STA, and STP of the drawing control information register 334, and the specification of subpicture display on/off, which is specified by the subpicture stream control information input from the navigation manager 11. If the current time is within a period during which a subpicture should be displayed, the subpicture drawing section 335 draws the pixel data stored in the connected pixel data buffer 223 in order to generate a subpicture image by using the COLOR, CONTR, DAREA, DSPXA, and PXCD of the drawing control information register 225, the highlight information HLI from the PCI and HLI decoder 125, and the button status information indicating the button selected/determined status input from the navigation manager 11, and this image is output to the combining control section 126.

As a result of the above, when compared with the above-described subpicture processing section 124 shown in FIG. 5, when the subpicture stream is changed, a certain amount of overhead due to the process for causing each variable of the drawing control information register 334 to match the current time before the subpicture of the subpicture stream after being changed is displayed occurs. However, a change of a subpicture stream having a higher responsiveness is made possible in a simpler configuration.

In the above embodiment, although the stream processing sections 22 and 31 are provided so as to correspond to all the decoding subpicture streams, these may be provided so as not necessarily to correspond to all the decoding subpicture streams.

For example, in a case where the stream processing sections 22 and 31 are dynamically assigned to the decoding subpicture streams, the decoding subpicture stream of the decoding subpicture stream number which does not correspond to the current video display aspect ratio and/or the current video display mode, which are determined by referring to the PGC_SPST_CTLT of PGCI of the PGC currently being played back, is a decoding subpicture stream which is not used in the current condition. Therefore, the stream processing sections 22 and 31 may not be assigned to this decoding subpicture stream. For example, when video having video attributes of 16:9, determined by referring to VMGM_V_ATRT/VTSM_V_ATRT/VTS_V_ATRT of the presentation being played back is being displayed in the letter-box display mode in the display mode of 4:3, the stream processing sections 22 and 31 may not be assigned to the subpicture streams corresponding to pan-and-scan. Furthermore, when video having video attributes of 16:9 is being displayed in the pan-and-scan display mode in the display mode of 4:3, the stream processing sections 22 and 31 may not be assigned to the subpicture stream corresponding to letter box. Furthermore, when video having video attributes of 16:9 is being displayed in the display mode of 16:9, the stream processing sections 22 and 31 may not be assigned to the subpicture streams corresponding to letter box and pan-and-scan.

Alternatively, in the initial state, the subpicture stream to which the stream processing sections 22 and 31 are assigned may be limited by considering each language code and/or each language code extension to which the subpicture stream corresponds, which are determined by referring to the VMG_SPST_ATRT, VTSM_SPST_ATRT, VTS_SPST_ATRT, etc., and the stream processing sections 22 and 31 may be assigned to only the decoding subpicture stream corresponding to the subpicture stream to which the stream processing sections 22 and 31 are assigned, which is determined by referring to the PGC_SPST_CTLT of PGCI of the PGC currently being played back. However, in the initial state, with regard to the subpicture streams of the language code and the language code extension to which the stream processing sections 22 and 31 are not assigned, the stream processing section 22 is assigned when that subpicture stream is selected. For example, when subpicture streams, in which the language codes of Japanese, English, and a certain language are set, exist, assuming that the frequency at which the subpicture stream of that certain language is used is low, the stream processing sections 22 and 31 may not be assigned in the initial state. Even in this case, the change of the subpicture stream to the subpicture stream of the language and the language code extension to which the stream processing sections 22 and 31 are not assigned is the same as in the conventional case.

The above-described DVD-video playback apparatus may be realized as a process implemented by executing a program on a computer system.

Furthermore, in the foregoing, a description has been given by using as an example a change of a subpicture stream in a DVD-video playback apparatus. The control technique for changing a stream, described in this embodiment, can be applied in the same way to any playback apparatus for selecting one stream from a plurality of streams and playing back the stream regardless of whether that playback apparatus plays back a presentation from a recording medium or regardless of whether that playback apparatus plays back a presentation received by communication.

As has thus been described, according to the present invention, in a DVD-video playback apparatus, the responsiveness to an instruction for changing a subpicture stream can be improved.

What is claimed is:

1. A DVD-video playback apparatus for playing back a presentation containing a plurality of subpicture streams recorded on a DVD-video disk, said DVD-video playback apparatus comprising:
a data reading section for reading data of the presentation from said DVD-video disk;
a subpicture stream data storage section for storing, for each subpicture stream, the data of each subpicture stream which is contained in the data of the presentation read by said data reading section;
a subpicture playback section for playing back a subpicture stream from the data of the subpicture streams; and
a subpicture stream data selection section for selecting the data of the subpicture stream to be played back by the subpicture playback section from among the data of each subpicture stream stored by said subpicture stream data storage section, in accordance with an instruction to change the subpicture stream to be played back.

2. A DVD-video playback apparatus according to claim 1, wherein said subpicture stream data storage section stores, for each subpicture stream, the data of only the subpicture streams corresponding to the current display aspect ratio and/or the current display mode, which are determined by referring to a program chain subpicture stream control table (PGC_SPST_CTLT) of program chain information (PGCI) of a program chain (PGC) currently being played back.

3. A DVD-video playback apparatus according to claim 1, wherein said subpicture stream data storage section stores, for each subpicture stream, the data of only the subpicture streams corresponding to a predetermined language code and/or a predetermined language code extension, which are determined by referring to a subpicture stream attribute table (SPST_ATRT) of the presentation currently being played back.

4. A DVD-video playback apparatus for playing back a presentation containing a plurality of subpicture streams recorded on a DVD-video disk, said DVD-video playback apparatus comprising:
a data reading section for reading data of the presentation from said DVD-video disk;
a plurality of stream processing sections provided in such a manner as to correspond to the plurality of subpicture streams;
a selection section for selecting one stream processing section from among the plurality of stream processing sections; and
a subpicture playback section for playing back a subpicture,
wherein each of said stream processing sections stores data of the most recent subpicture unit (SPU) of the subpicture stream corresponding to the stream processing section, which is contained in the data of the presentation read by said data reading section,
said selection section changes said stream processing section to be selected to said stream processing section corresponding to a subpicture stream after being changed in accordance with an instruction to change the subpicture stream to be played back, and
said subpicture playback section plays back a subpicture in accordance with the data of the subpicture unit stored by said stream processing section selected by said selection section.

5. A DVD-video playback apparatus according to claim 4, wherein, when said stream processing section selected by said selection section is changed, said subpicture playback section computes the value of a variable for subpicture display control at the current time, which is specified by a subpicture display control sequence table (SP_DCSQT) contained in the data of the subpicture unit stored by the selected stream processing section, and controls the display of pixel data (PXD) contained in the data of that subpicture unit in accordance with the computed value of the variable, thereby performing a first playback of the subpicture indicated by the data of that subpicture unit.

6. A DVD-video playback apparatus according to claim 4, wherein said stream processing section decodes and stores pixel data (PXD) contained in the most recent subpicture unit (SPU) of the subpicture stream corresponding to the stream processing section.

7. A DVD-video playback apparatus for playing back a presentation containing a plurality of subpicture streams recorded on a DVD-video disk, said DVD-video playback apparatus comprising:
a data reading section for reading data of the presentation from said DVD-video disk;
a plurality of stream processing sections provided in such a manner as to correspond to the plurality of subpicture streams;
a selection section for selecting one stream processing section from among the plurality of stream processing sections; and
a subpicture playback section for playing back a subpicture stream,
wherein each of said stream processing sections stores pixel data (PXD) contained in the most recent subpicture unit (SPU) of the subpicture stream corresponding to the stream processing section, which is contained in the data of the presentation read by said data reading section, computes the value of a variable for subpicture display control at the current time, which is specified by a subpicture display control sequence table (SP_DCSQT) contained in the data of that subpicture unit, and stores the value,
said selection section changes said stream processing section to be selected to said stream processing section corresponding to a subpicture stream after being changed in accordance with an instruction to change the subpicture stream to be played back, and
said subpicture playback section plays back a subpicture by controlling the display of the pixel data stored by that stream processing section in accordance with the value of the variable stored by said stream processing section selected by said selection section.

8. A playback apparatus for playing back a presentation containing a plurality of streams, said playback apparatus comprising:
a stream data storage section for storing, for each stream, data of each stream which is contained in the data of an input presentation; and
a stream playback section for reading data of a stream to be played back from said stream data storage section and playing back the stream.

9. A subpicture stream playback control method for controlling the playback of subpicture streams in a DVD-video playback apparatus for playing back a presentation containing a plurality of subpicture streams recorded on a DVD-video disk, said subpicture stream playback control method comprising:
reading data of the presentation from said DVD-video disk;
storing, for each subpicture stream, data of each subpicture stream which is contained in the read presentation data;
selecting, from among the data of each of said stored subpicture streams, the data of a subpicture stream to be played back in accordance with an instruction to change the subpicture stream to be played back; and
playing back a subpicture stream from the data of the selected subpicture stream.

10. A computer program executed by a computer, said computer program comprising the acts of:
reading data of the presentation from said DVD-video disk on which the presentation containing a plurality of subpicture streams is recorded;
storing, for each subpicture stream, data of each subpicture stream which is contained in the data of the read presentation;
selecting, from among the data of each of the stored subpicture streams, the data of a subpicture stream to be played back in accordance with an instruction to change the subpicture stream to be played back; and
playing back a subpicture stream from the data of the selected subpicture stream.

11. A recording medium having recorded thereon a computer program according to claim 10.

12. A DVD-video playback method for playing back a presentation containing a plurality of subpicture streams recorded on a DVD-video disk, said DVD-video playback method comprising:
reading data of the presentation from said DVD-video disk;
storing, for each subpicture stream, the data of each subpicture stream which is contained in the data of the read presentation;
playing back a subpicture stream from the data of the stored subpicture stream; and
selecting the data of a subpicture stream to be played back in accordance with an instruction to change the subpicture stream to be played back, from among the data of each of said subpicture streams.

13. A DVD-video playback method for playing back a presentation containing a plurality of subpicture streams recorded on a DVD-video disk, said DVD-video playback method comprising:
reading data of the presentation from said DVD-video disk;
storing data of the most recent subpicture unit (SPU) of the subpicture stream corresponding to the stream, contained in the data of the read presentation in such a manner as to correspond to each of a plurality of subpicture streams;
changing, when one stream is selected from the plurality of streams, to said stream corresponding to the subpicture stream after being changed in accordance with an instruction to change the subpicture stream to be played back; and
playing back a subpicture in accordance with the data of the subpicture unit stored by said selected stream.

14. A DVD-video playback method for playing back a presentation containing a plurality of subpicture streams recorded on a DVD-video disk, said DVD-video playback method comprising:
reading data of the presentation from said DVD-video disk;
storing pixel data (PXD) contained in the most recent subpicture unit (SPU) corresponding to the stream, which is contained in the data of the presentation read in such a manner as to correspond to a plurality of subpicture streams, computing the value of a variable for subpicture display control at the current time, which is specified by a subpicture display control sequence table (SP_DCSQT) contained in the data of that subpicture unit, and storing the value;
changing, when one stream is selected from the plurality of streams, to said stream corresponding to the subpicture stream after being changed in accordance with an instruction to change the subpicture stream to be played back; and
playing back a subpicture by controlling the display of the stored pixel data in accordance with the value of the variable stored by said selected stream processing section.

15. A playback method for playing back a presentation containing a plurality of streams, said playback method comprising the steps of:
storing, for each stream, data of each stream, which is contained in the data of the input presentation;
reading the data of the stream to be played back from each item of the stored stream data; and
playing back the stream.

16. A playback apparatus for receiving communication of a presentation containing a plurality of subpicture streams and playing back the presentation, said playback apparatus comprising:
a data reading section for reading data of the presentation;
a subpicture stream data storage section for storing, for each subpicture stream, data of each subpicture stream which is contained in the data of the presentation read by said data reading section;
a subpicture playback section for playing back a subpicture stream from the data of the subpicture stream; and
a subpicture stream data selection section for selecting data of a subpicture stream to be played back by the subpicture playback section from among the data of each subpicture stream stored by said subpicture stream data storage section, in accordance with an instruction to change the subpicture stream to be played back.

17. A playback apparatus according to claim 16, wherein said subpicture stream data storage section stores, for each subpicture stream, the data of only the subpicture stream corresponding to a predetermined language code and/or a predetermined language code extension, which are determined by referring to a subpicture stream attribute table (SPST_ATRT) of the presentation currently being played back.

18. A playback apparatus for receiving communication of a presentation containing a plurality of subpicture streams and playing back the presentation, said playback apparatus comprising:
a data reading section for reading data of the presentation received through said communication;
a plurality of stream processing sections provided in such a manner as to correspond to a plurality of subpicture streams;
a selection section for selecting one stream processing section from among the plurality of stream processing sections; and
a subpicture playback section for playing back a subpicture,
wherein each of said stream processing sections stores data of the most recent subpicture unit (SPU) of the subpicture stream corresponding to the stream processing section, contained in the data of the presentation read by said data reading section,
said selection section changes said stream processing section to be selected to said stream processing section corresponding to the subpicture stream after being changed in accordance with an instruction to change the subpicture stream to be played back, and
said subpicture playback section plays back a subpicture in accordance with the data of the subpicture unit stored by said stream processing section selected by said selection section.

19. A playback apparatus according to claim 18, wherein said stream processing section decodes and stores pixel data (PXD) contained in the most recent subpicture unit (SPU) of the subpicture stream corresponding to the stream processing section.

20. A subpicture stream playback control method for controlling the playback of a subpicture stream in a playback apparatus for receiving communication of a presentation containing a plurality of subpicture streams and playing back the presentation, said subpicture stream playback control method comprising:
reading data of the presentation received through said communication;
storing, for each subpicture stream, the data of each subpicture stream which is contained in the data of the read presentation;
selecting the data of the subpicture stream to be played back from among the data of the stored subpicture streams, in accordance with an instruction to change the subpicture stream to be played back; and
playing back the subpicture stream from the data of the selected subpicture stream.
